(19) United States
(12) Patent Application Publication
(10) Pub. No.: US 2017/0155727 A1
(43) Pub. Date: Jun. 1, 2017

(54) METHOD AND ELECTRONIC DEVICE FOR INFORMATION PUSHING IN SMART TELEVISION

(71) Applicants: Le Holdings (Beijing) Co., Ltd., Beijing (CN); LE SHI INTERNET INFORMATION & TECHNOLOGY CORP., BEIJING, Beijing (CN)

(72) Inventors: Zhimin Yin, Beijing (CN); Xi Yang, Beijing (CN)

(21) Appl. No.: 15/241,133

(22) Filed: Aug. 19, 2016

Related U.S. Application Data
(63) Continuation of application No. PCT/CN2016/088238, filed on Jul. 1, 2016.

(30) Foreign Application Priority Data
Dec. 1, 2015 (CN) 201510867874.1

(51) Int. Cl. H04L 29/08; H04N 21/433

(52) U.S. Cl. CPC H04L 67/26; H04N 21/4331

(57) ABSTRACT

The disclosure provides a method and an electronic device for information pushing in smart television, wherein the method includes presetting a push condition parameter; sending, by server terminal, a connection request to the smart television terminal; judging whether the connection request is successful; if so, sending multimedia information matched with the preset push condition parameter to the smart television terminal; otherwise, storing the multimedia information; receiving, by the smart television terminal, the multimedia information sent by the server terminal; displaying the multimedia information received. With the method for information pushing in smart television in the disclosure, specific information may be pushed to users, thereby achieving the effect of centralized management of users.

### CROSS REFERENCE TO RELATED APPLICATIONS

This application is a continuation of International Application No. PCT/CN2016/088238 submitted on Jul. 1, 2016, which claims priority to Chinese Patent Application No. 201510867874.1, entitled “SYSTEM AND METHOD FOR INFORMATION PUSHING IN SMART TELEVISION”, filed before the State Intellectual Property Office of China on Dec. 1, 2015, the entire contents of which are incorporated herein by reference.

### TECHNICAL FIELD

The disclosure relates to the field of smart televisions, and specifically to a method and an electronic device for information pushing in smart television.

### BACKGROUND

Smart television, as a new product formed based on the impact of Internet wave, has a goal to bring more convenient experiences to users and has become a trend of television now. The integration between television and network is an important development direction for television at present. Smart television can provide more experiences to users through network; however, at present, the smart televisions used by most people are in an independent state, in which the smart television cannot be integrated with neighborhood services, cannot customize service information needed by users, for example, property service, information issue, smart home, convenient information, businesses surrounding community and so on, and cannot let users get better experiences.

### SUMMARY

The embodiment of the disclosure provides a method and an electronic device for information pushing in smart television, which can push specific information to users, thereby achieving an effect of centralized management of users.

In the first aspect, the embodiments of the disclosure provide a method for information pushing in smart television, which is applied to a server terminal, including:

presetting a push condition parameter;

sending a connection request to a smart television terminal;

judging whether the connection request is successful; if so, sending multimedia information matched with the preset push condition parameter to the smart television terminal, such that the smart television terminal receive and thus display the multimedia information sent by the server terminal; otherwise, storing the multimedia information.

In the second aspect, the embodiments of the disclosure further provide a nonvolatile computer storage media having computer executable instructions stored thereon, wherein the computer executable instructions can execute any one of the foregoing method for information pushing in smart television in the disclosure.

In the third aspect, the embodiments of the disclosure also provide an electronic device, including: one or more processors; and a memory; wherein, the memory is stored with instructions executable by the one or more processors, the instructions are configured to execute any one of the foregoing method for information pushing in smart television in the disclosure.

The embodiment of the disclosure brings the following benefits: a connection is established between a server and a smart television terminal; when the smart television terminal is in an online state, specific information may be directly pushed to a user; when the smart television terminal is in an offline state, the specific information needing to be pushed may be cached in the server, and, once the smart television terminal is in an online state, the cached information may be pushed to the smart television terminal; thus, an effect of centralized management of users is achieved.

### BRIEF DESCRIPTION OF THE DRAWINGS

For a better understanding of the embodiments of the disclosure or the technical scheme of the existing technology, a brief introduction is given below to the drawings needed in the description of the embodiments or existing technology. Obviously, the following drawings are some embodiments of the disclosure simply; for those skilled in the art, other drawings can be obtained according to these drawings without creative work.

FIG. 1 is a structure diagram of an information push system for a smart television provided in the disclosure.

FIG. 2 is a structure diagram of an embodiment of FIG. 1.

FIG. 3 is a flowchart of an information push method for a smart television provided in the disclosure.

FIG. 4 is a schematic diagram of a structure of a hardware of the electronic device of the method for information pushing in smart television according to the disclosure.

### DESCRIPTION OF THE EMBODIMENTS

A clear and complete description is provided to the technical scheme in the embodiments of the disclosure in conjunction with the drawings in the embodiments of the disclosure. Obviously, the embodiments described hereinafter are simply part embodiments of the disclosure, but not all the embodiments. All other embodiments obtained by those skilled in the art based on the embodiments in the disclosure without creative work are intended to be included in the scope of protection of the disclosure.

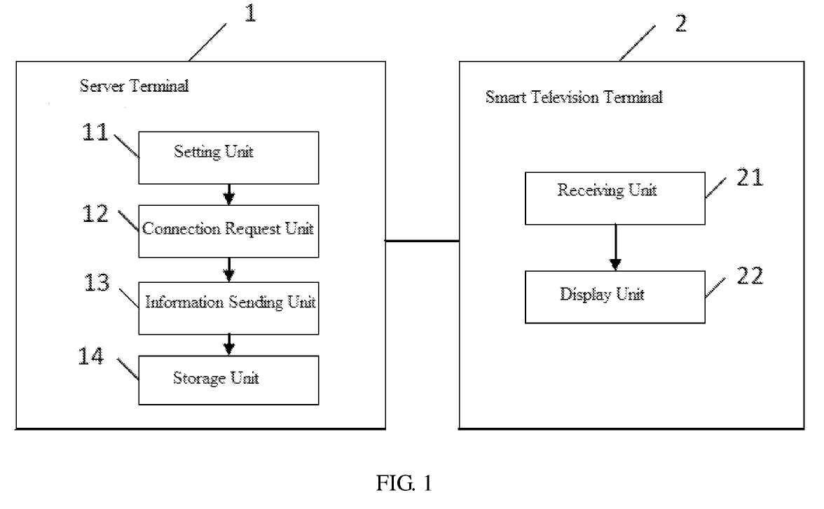

Refer to FIG. 1, which is a structure diagram of an information push system for a smart television provided in the disclosure. The system includes a server terminal 1 and a smart television terminal 2, wherein the server terminal 1 includes:

a setting unit 11, which is configured to preset a push condition parameter.

In particular, in order to relieve the communication congestion between the server terminal 1 and the smart television terminal 2, a condition parameter for pushing information to the smart television terminal 2 needs to be preset, the condition parameter including information type, information name or judgment of threshold, wherein the judgment of threshold is a judgment of the number of push times or a judgment of the time interval of push; by the setting of a certain number of push times or a certain time interval of push, the information to be pushed is ensured not to expire.

A connection request unit 12, which is configured to send a connection request to the smart television terminal 2.

In particular, when the server terminal 1 needs to push information to the smart television terminal 2, the server terminal 1 sends a connection request to the smart television terminal through TCP (Transmission Control Protocol).

An information sending unit 13, which is configured to send multimedia information matched with the preset push condition parameter to the smart television terminal 2 when the connection request is sent successfully.

In particular, when the connection request is sent successfully, it is indicated that the smart television terminal 2 is in an online state, and the server terminal 1 may directly send multimedia information matched with the preset push condition parameter to the smart television terminal 2, the multimedia information including one of a text, an image, a video and a document, or combinations thereof.

A storage unit 14, which is configured to store the multimedia information when the connection request is sent unsuccessfully.

In particular, when the connection request is sent unsuccessfully, it is indicated that the smart television terminal 2 is in an offline state temporarily, and the server terminal 1 caches the multimedia information to be pushed; once the server terminal 1 detects that the smart television terminal 2 is in an online state, the server terminal 1 sends the multimedia information to be pushed.

The smart television terminal 2 includes:

a receiving unit 21, which is configured to receive the multimedia information sent by the server terminal; and

a display unit 22, which is configured to display the multimedia information received by the receiving unit.

In particular, when the smart television terminal 2 receives the multimedia information sent by the server terminal 1, the smart television terminal 2 displays the multimedia information on a screen thereof, wherein the location area on the smart television terminal 2 for displaying the multimedia information is not limited, for example, the location area may be on the top, bottom or lateral side and the like of the smart television terminal 2.

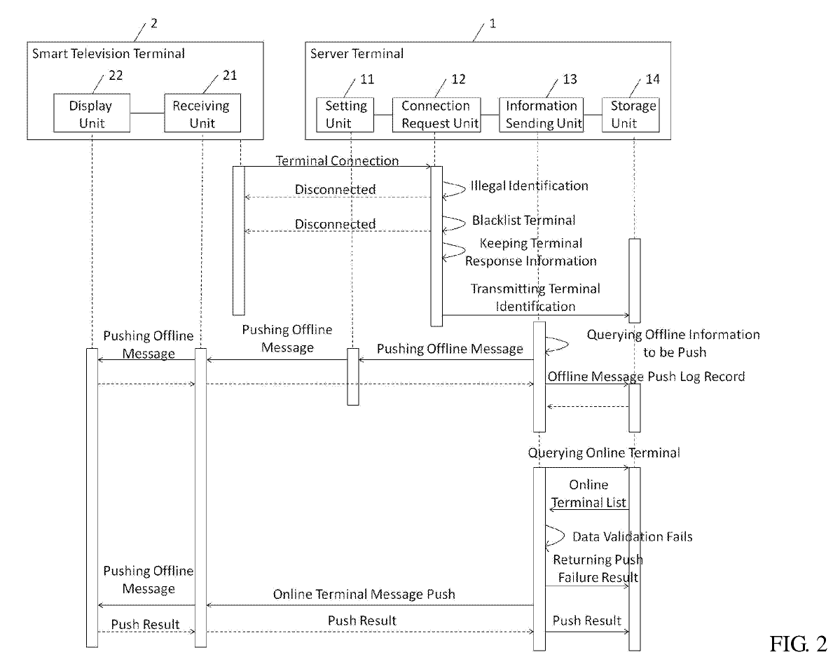

Refer to FIG. 2, which is one embodiment of FIG. 1. When the smart television terminal 2 is started, the connection request unit 12 in the server terminal 1 establishes a network connection with the smart television terminal 2, then the storage unit 14 in the server terminal 1 judges whether the connected smart television terminal 2 is an illegal terminal or a blacklist terminal; if so, the connection request unit 12 disconnects with the smart television terminal 2 and meanwhile transmits the terminal identification to the storage unit 14 to store. If the connected smart television terminal 2 is a legal terminal and an offline message is queried needing to be pushed, the offline message is pushed to the receiving unit 21 of the smart television terminal 2 through the information sending unit 13, then the offline message received by the receiving unit 21 is displayed through the display unit 22 and an offline message push log record is fed back to the storage unit 14. It should be noted that the offline message is multimedia information, including one of a text, an image, a video and a document, or combinations thereof.

Meanwhile, when the server terminal 1 needs to send a message to the smart television terminal 2, the information sending unit 13 sends an online terminal query request to the storage unit 14; when the information sending unit 13 receives an online terminal list fed back by the storage unit 14, the information sending unit 13 judges whether the message to be sent is matched with the push condition parameter preset by the setting unit 11; if so, the information sending unit 13 pushes the message to the online smart television terminal 2, and the smart television terminal 2 feeds back a push result to the storage unit 14; otherwise, the information sending unit 13 returns a push failure result to the storage unit 14. It should be noted that the push condition parameter includes information type, information name or judgment of threshold, wherein the judgment of threshold is a judgment of the number of push times or a judgment of the time interval of push.

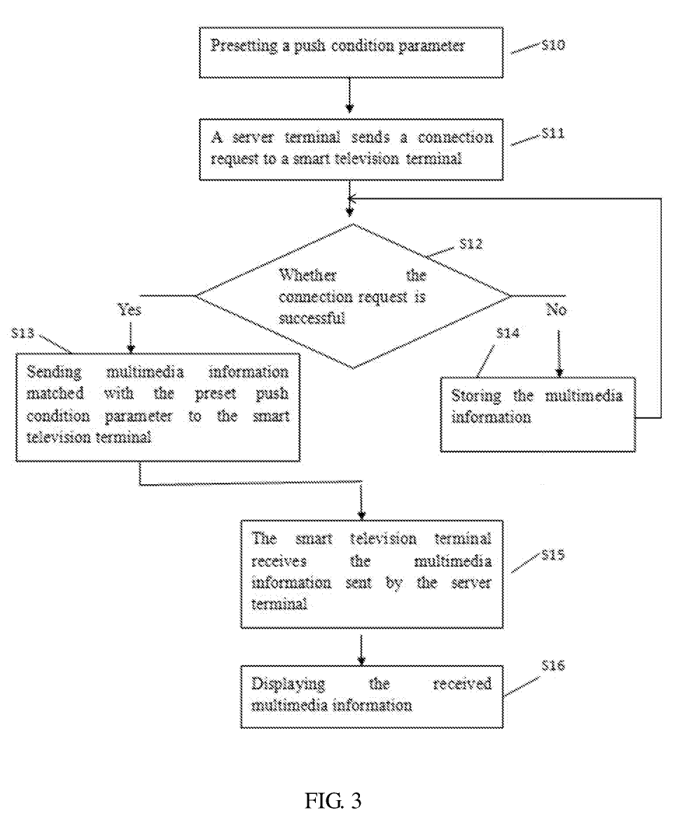

Refer to FIG. 3, which is a flowchart of an information push method for a smart television terminal provided in the disclosure, specifically including:

S10: presetting a push condition parameter by a server.

In particular, in order to relieve the communication congestion between a server terminal and a smart television terminal, a condition parameter for pushing information to the smart television terminal needs to be preset, the condition parameter including information type, information name or judgment of threshold, wherein the judgment of threshold is a judgment of the number of push times or a judgment of the time interval of push; by the setting of a certain number of push times or a certain time interval of push, the information to be pushed is ensured not to expire.

S11: sending a connection request to a smart television terminal.

In particular, when the server terminal needs to push information to the smart television terminal, the server terminal sends a connection request to the smart television terminal through TCP (Transmission Control Protocol).

S12: judging whether the connection request is successful; if so, skip to S13, otherwise, skip to S14.

S13: sending multimedia information matched with the preset push condition parameter to the smart television terminal; after accomplishing the execution of S13, skipping to S15.

In particular, when the connection request is sent successfully, it is indicated that the smart television terminal is in an online state, and the server terminal may directly send multimedia information matched with the preset push condition parameter to the smart television terminal, the multimedia information including one of a text, an image, a video and a document, or combinations thereof.

S14: storing the multimedia information; and returning to execute S12.

In particular, when the connection request is sent unsuccessfully, it is indicated that the smart television terminal 2 is in an offline state temporarily, and the server terminal 1 caches the multimedia information to be pushed; once the server terminal 1 detects that the smart television terminal 2 is in an online state, the server terminal 1 sends the multimedia information to be pushed.

S15: the smart television terminal receives the multimedia information sent by the server terminal.

S16: displaying the received multimedia information by the smart television.

In particular, when the smart television terminal receives the multimedia information sent by the server terminal, the smart television terminal displays the multimedia information on a screen thereof, wherein the location area on the smart television terminal for displaying the multimedia information is not limited, for example, the location area may be on the top, bottom or lateral side and the like of the smart television terminal.

To sum up, a connection is established between a server and a smart television terminal; when the smart television terminal is in an online state, specific information may be directly pushed to a user; when the smart television terminal is in an offline state, the specific information needing to be pushed may be cached in the server, and, once the smart television terminal is in an online state, the cached information may be pushed to the smart television terminal; thus, an effect of centralized management of users is achieved.

An embodiment of the disclosure provides a nonvolatile computer storage media having computer executable instructions stored thereon, wherein the computer executable instructions can perform S10-S16 of the method for information pushing in smart television according to the foregoing embodiments of methods.

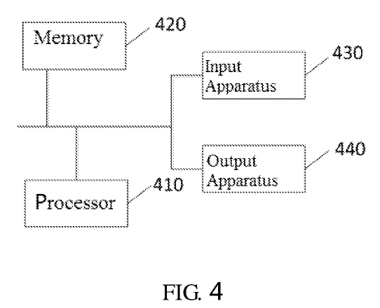

FIG. 4 is a schematic diagram of a structure of a hardware of the electronic device of the method for information pushing in smart television according to the embodiments of the disclosure, as shown in FIG. 4, the apparatus includes:

one or more processors 410 and a memory 420, in FIG. 4, one processor 410 is employed as an example.

The electronic device of the method for information pushing in smart television may further include: an input apparatus 430 and an output apparatus 440.

The processor 410, the memory 420, the input apparatus 430 and the output apparatus 440 may be connected via a bus or other means, in FIG. 4, a connection via a bus is taken as an example.

As a nonvolatile computer readable storage media, the memory 420 can be used to store nonvolatile software program, nonvolatile computer executable program and module, such as the program instructions/modules corresponding to the method for information pushing in smart television in the embodiments of the present application (e.g., the server terminal 1 and the smart television terminal 2 as shown in FIG. 1). The processor 410 executes various functions and applications of a server and data processing by running a nonvolatile software program, instructions and a module stored in the memory 420, so as to carry out S10-S16 of the processing method for information pushing in smart television in the embodiments above.

The memory 420 may include a program storage area and a data storage area, wherein the program storage area can store an operating system, an application program required for at least one function; the data storage area can store the data created based on the use of the apparatus for spatial positioning in a virtual reality system, or the like. Further, the memory 420 may include high-speed random access memory, and may further include nonvolatile memory, such as at least one disk storage device, flash memory device, or other nonvolatile solid-state memory devices. In some embodiments, the memory 420 optionally includes a memory remotely located with respect to the processor 410, which may be connected to an apparatus for spatial positioning in a virtual reality system via a network. Examples of such network include, but not limited to, Internet, Intranet, local area network (LAN), mobile communication network, and combinations thereof.

The input apparatus 430 may receive the input numbers or characters information, as well as key signal input associated with user settings of the apparatus for spatial positioning in a virtual reality system and function control. The output apparatus 440 may include a display screen or other display device.

The one or more modules are stored in the memory 420, and when being executed by the one or more processors 410, execute the method for information pushing in smart television according to the above embodiments of method.

The above mentioned products can perform the method provided by the embodiments of the present application, and they have the function modules and beneficial effects corresponding to this method. With respect to the technical details that are not detailed in this embodiment, please refer to the methods provided by the embodiments of the present application.

The electronic device according to the embodiments of the present application may have many forms, for example, including, but not limited to:

(1) mobile communication device: the characteristic of such device is: it has the function of mobile communication, and takes providing voice and data communications as the main target. Such type of terminal includes: smart phones, multimedia phones, feature phones and low-end mobile phones.

(2) ultra mobile PC device: this type of device belongs to the category of personal computer, it has the capabilities of computing and processing, and generally has the feature of mobile Internet access. Such type of terminal includes: PDA, MID and UMPC devices.

(3) portable entertainment device: this type of device can display and play multimedia content. Such type of device includes: audio players, video players, handheld game consoles, e-books, as well as smart toys and portable vehicle navigation devices.

(4) server: it provides computing services, and the structure of the server includes: a processor, a hard disk, a memory, a system bus and the like, its construction is similar to a general computer, but there is higher requirement on the processing capability, stability, reliability, security, scalability, manageability and other aspects of the server as highly reliable service is needed to provide.

(5) other electronic device that has the function of data exchange.

The apparatus of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

Finally, it should be noted that: the above embodiments are merely provided for describing the technical solutions of the present invention, but not intended to limit thereto; although the present invention has been described in detail with reference to the foregoing embodiments, those skilled in the art will appreciate that: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

What is claimed is:

1. A method for information pushing in smart television, which is applied to sever terminal, comprising:
presetting a push condition parameter;
sending a connection request to a smart television terminal;
judging whether the connection request is successful; if so, sending multimedia information matched with the preset push condition parameter to the smart television terminal, such that the smart television terminal receive and display the multimedia information sent by the server terminal; otherwise, storing the multimedia information.

2. The method for information pushing in smart television according to claim 1, wherein the push condition parameter comprises information type, information name or judgment of threshold.

3. The method for information pushing in smart television according to claim 2, wherein the judgment of threshold is a judgment of the number of push times or a judgment of the time interval of push.

4. The method for information pushing in smart television according to claim 1, wherein the multimedia information comprises one of a text, an image, a video and a document, or combinations thereof.

5. A nonvolatile computer storage media, which has computer executable instructions stored thereon, wherein the computer executable instructions are configured to:
presetting a push condition parameter;
sending a connection request to a smart television terminal;
judging whether the connection request is successful; if so, sending multimedia information matched with the preset push condition parameter to the smart television terminal, such that the smart television terminal receive and display the multimedia information sent by the server terminal; otherwise, storing the multimedia information.

6. The nonvolatile computer storage media according to claim 5, wherein the push condition parameter comprises information type, information name or judgment of threshold.

7. The nonvolatile computer storage media according to claim 6, wherein the judgment of threshold is a judgment of the number of push times or a judgment of the time interval of push.

8. The nonvolatile computer storage media according to claim 5, wherein the multimedia information comprises one of a text, an image, a video and a document, or combinations thereof.

9. An electronic device, comprising:
one or more processors; and
a memory; wherein,
the memory is stored with instructions executable by the one or more processors, the instructions are configured to execute:
presetting a push condition parameter;
sending a connection request to a smart television terminal;
judging whether the connection request is successful; if so, sending multimedia information matched with the preset push condition parameter to the smart television terminal, such that the smart television terminal receive and thus display the multimedia information sent by the server terminal; otherwise, storing the multimedia information.

10. The electronic device according to claim 9, wherein the push condition parameter comprises information type, information name or judgment of threshold.

11. The electronic device according to claim 10, wherein the judgment of threshold is a judgment of the number of push times or a judgment of the time interval of push.

12. The electronic device according to claim 9, wherein the multimedia information comprises one of a text, an image, a video and a document, or combinations thereof.
